(19) United States
(12) Patent Application Publication
(10) Pub. No.: US 2020/0108492 A1
(43) Pub. Date: Apr. 9, 2020

(54) PULLER STRUCTURE

(71) Applicant: Chih Kuo Hu, Taichung City (TW)

(72) Inventor: Chih Kuo Hu, Taichung City (TW)

(21) Appl. No.: 16/154,104

(22) Filed: Oct. 8, 2018

(51) Int. Cl. B25B 27/02; B25B 27/06

(52) U.S. Cl. CPC B25B 27/023; B25B 27/062

(57) ABSTRACT

A puller structure includes a threaded rod, a connecting member, a fixing base, and a driven base. The connecting member is topped with a wing nut. The threaded rod extends downward through the wing nut, the fixing base, and the driven base. The connecting member has a lower portion fixedly connected to the driven base. The fixing base includes a plurality of first fixing arms that extend obliquely downward. The driven base includes a plurality of second fixing arms that extend outward. The first fixing arms correspond in position respectively to and are shorter than the second fixing arms. Each first or second fixing arm is provided with a groove that extends in the same direction as the fixing arm. A gripping arm is slidably provided in the grooves of each corresponding pair of fixing arms through two pairs of protruding blocks respectively.

### BACKGROUND OF THE INVENTION

### 1. Technical Field

The present invention relates to hand tools and more particularly to the structure of a puller.

### 2. Description of Related Art

Conventional pullers can be divided into two structural configurations as shown respectively in FIG. 5 and FIG. 6. In either configuration, a plurality of gripping arms are configured to be fastened securely to a workpiece (e.g., a bearing) so that a shaft can be pushed into or pulled out of the workpiece via the spiral action of a threaded rod. Whether a conventional puller can work properly and achieve the intended effect, therefore, depends on whether its gripping arms can be securely fastened to a workpiece. In particular, the larger a workpiece is, the greater the gripping distance formed between the gripping arms must be in order to fasten the gripping arms securely to the workpiece.

Referring to the conventional puller in FIG. 5, each gripping arm 71 is pivotally connected at the top end to a connecting arm 72 of a fixed length and is also connected to a driving arm 73. The driving arms 73 can push the gripping arms 71 outward respectively to form the desired gripping distance. The greatest distance to which the gripping arms 71 can be pushed outward with respect to each other is referred to as the span of the gripping arms 71. When this puller is used on a relatively large workpiece 74 whose size is smaller than the span of the gripping arms 71 but larger than the maximum effective gripping distance between the gripping arms 71 as shown in FIG. 5, the gripping arms 71, which are pivotally connected to the connecting arm 72 at fixed positions and hence do not allow the gripping distance to be further increased, cannot grip the workpiece 74 securely.

Referring to the conventional puller in FIG. 6, each gripping arm 81 is slidably connected at the top end to a connecting arm 82 of a fixed length, and the gripping distance between the gripping arms 81 is equal to the span of the gripping arms 81; that is to say, the distance between the gripping arms 81 dictates the size of a workpiece 83 that can be securely gripped by the gripping arms 81. This type of pullers, however, generally have a relatively long connecting arm 82 that results in bulkiness and consequently inconvenience in storage.

### BRIEF SUMMARY OF THE INVENTION

The primary objective of the present invention is to provide a puller structure that has a greater span and can be opened wider than its prior art counterparts in order to be fixed on relatively large workpieces and have wider application than the conventional pullers.

To achieve the above objective, the present invention provides a puller structure that includes a threaded rod, a connecting member, a fixing base, and a driven base. The fixing base is provided with a threaded hole while the driven base is provided with a through hole. The top end of the connecting member is provided with a wing nut. The threaded rod extends downward through and is threadedly connected with the wing nut and the threaded hole of the fixing base and then extends through the through hole of the driven base. A plurality of extension arms extend downward from the connecting member and are arranged at intervals and fixedly connected to the driven base. A plurality of first fixing arms extend outward from the fixing base. A plurality of second fixing arms extend outward from the driven base. The first fixing arms extend through the gaps between the extension arms respectively and correspond in position to the second fixing arms vertically and respectively. In addition, each first fixing arm and the corresponding second fixing arm are connected with a gripping arm. The first fixing arms extend obliquely downward from the fixing base while the second fixing arms extend in a curved manner from the driven base. Each first fixing arm has a shorter length than the corresponding second fixing arm. Each first fixing arm is provided with a first groove that extends in the same direction as the first fixing arm, and each second fixing arm is provided with a second groove that extends in the same direction as the second fixing arm. Each gripping arm is slidably provided in the corresponding first groove and the corresponding second groove via two first protruding blocks and two second protruding blocks respectively.

In one embodiment, the first groove of each first fixing arm is upwardly concavely provided in the bottom side of the first fixing arm, each first fixing arm has two lateral sides each formed with a first slide slot, and a plurality of positioning recesses are provided along the bottom edge of each first slide slot in a wavy configuration. The first protruding blocks of each gripping arm are provided respectively on two lateral portions of the gripping arm that face the first slide slots of the corresponding first fixing arm respectively and extend through the first slide slots of the corresponding first fixing arm slidably and respectively. The second groove of each second fixing arm penetrates the second fixing arm vertically, and each second fixing arm has two lateral sides each formed with a second slide slot. The second protruding blocks of each gripping arm are provided respectively on two lateral portions of the gripping arm that face the second slide slots of the corresponding second fixing arm respectively and extend through the second slide slots of the corresponding second fixing arm slidably and respectively.

### BRIEF DESCRIPTION OF THE SEVERAL VIEWS OF THE DRAWINGS

FIG. 1 is a perspective view of a puller structure according to the present invention;

FIG. 2 is an exploded perspective view of the puller structure in FIG. 1;

FIG. 3 and FIG. 4 show certain states of use of the puller structure in FIG. 1;

FIG. 5 schematically shows a conventional puller structure; and

FIG. 6 schematically shows another conventional puller structure.

### DETAILED DESCRIPTION OF THE INVENTION

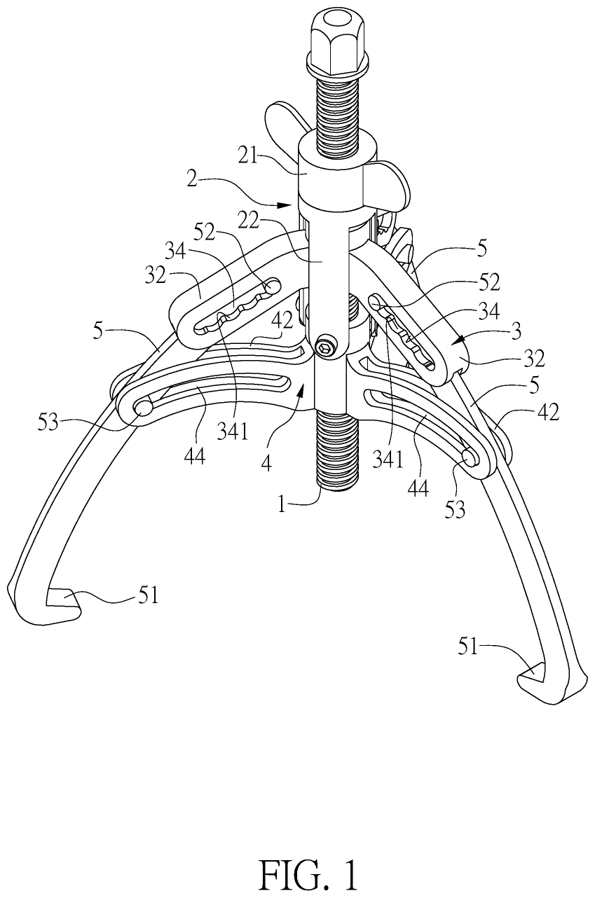

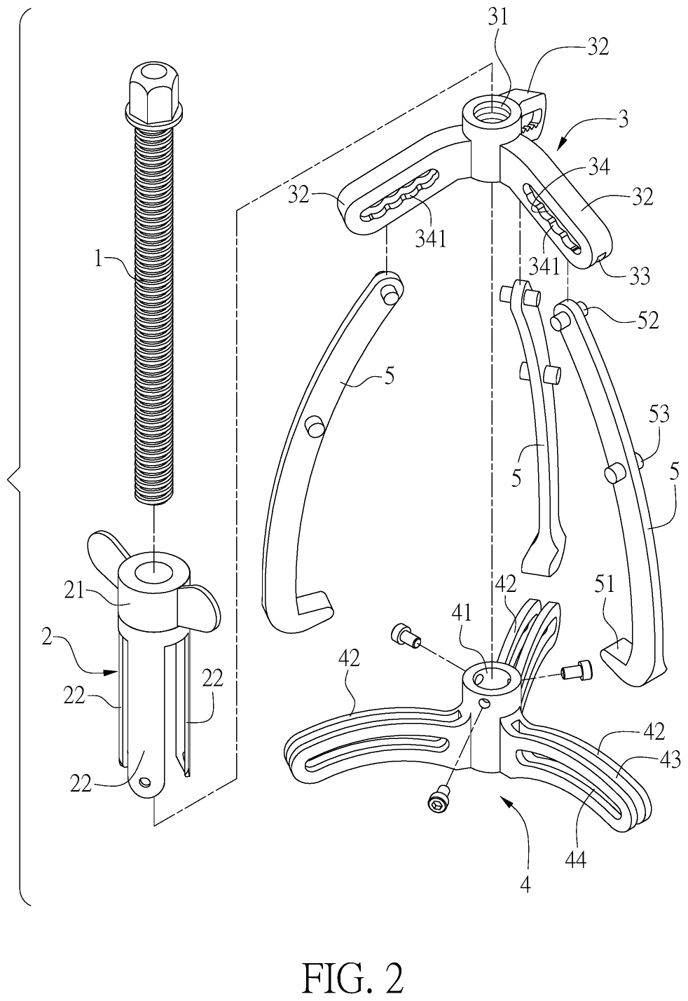

Referring to FIG. 1 and FIG. 2, the puller structure according to an embodiment of the present invention includes a threaded rod 1, a connecting member 2, a fixing base 3, and a driven base 4. The connecting member 2 is provided with a wing nut 21 at the top end. The fixing base 3 lies under the connecting member 2, and the driven base 4 lies under the fixing base 3. Three extension arms 22 extend downward from the connecting member 2 and are arranged at intervals and fixedly connected to the driven base 4. The fixing base 3 is provided with a threaded hole 31. The driven base 4 is provided with a through hole 41. The threaded rod 1 is threadedly connected to the wing nut 21, then extends downward to be threadedly connected to the fixing base 3 via the threaded hole 31, and extends further downward through the through hole 41 of the driven base 4.

The fixing base 3 is provided with three first fixing arms 32 that extend outward. The first fixing arms 32 extend through the gaps between the extension arms 22 respectively. More specifically, each first fixing arm 32 extends obliquely downward from the fixing base 3. The driven base 4 is provided with three second fixing arms 42 that extend outward. More specifically, each second fixing arm 42 extends from the driven base 4 in a curved manner. The positions of the first fixing arms 32 correspond vertically and respectively to those of the second fixing arms 42. The length of each first fixing arm 32 is shorter than that of the corresponding second fixing arm 42.

Each first fixing arm 32 is provided with a first groove 33 that extends in the same direction as the first fixing arm. In this embodiment, each first groove 33 is upwardly concavely provided in the bottom side of the corresponding first fixing arm 32, the two lateral sides of each first fixing arm 32 are each formed with a first slide slot 34, and the bottom edge of each first slide slot 34 is provided with a plurality of positioning recesses 341 that form a wavy shape. Each second fixing arm 42, on the other hand, is provided with a second groove 43 that extends in the same direction as the second fixing arm. In this embodiment, each second groove 43 penetrates the corresponding second fixing arm 42 vertically, and the two lateral sides of each second fixing arm 42 are each formed with a second slide slot 44.

Each pair of first and second fixing arms 32, 42 that correspond in position to each other are connected with a gripping arm 5. The bottom end of each gripping arm 5 is provided with a hook 51 to be hooked to a workpiece. Each gripping arm 5 extends through the second groove 43 of the corresponding second fixing arm 42 into the first groove 33 of the corresponding first fixing arm 32. The two lateral portions of each gripping arm 5 that face the first slide slots 34 of the corresponding first fixing arm 32 respectively are each provided with a first protruding block 52, and the two lateral portions of each gripping arm 5 that face the second slide slots 44 of the corresponding second fixing arm 42 respectively are each provided with a second protruding block 53. The first protruding blocks 52 and the second protruding blocks 53 of each gripping arm 5 are provided in the corresponding first slide slots 34 and the corresponding second slide slots 44 respectively in a slidable manner so that the positions at which each gripping arm 5 is connected respectively to the corresponding first fixing arm 32 and the corresponding second fixing arm 42 can be changed.

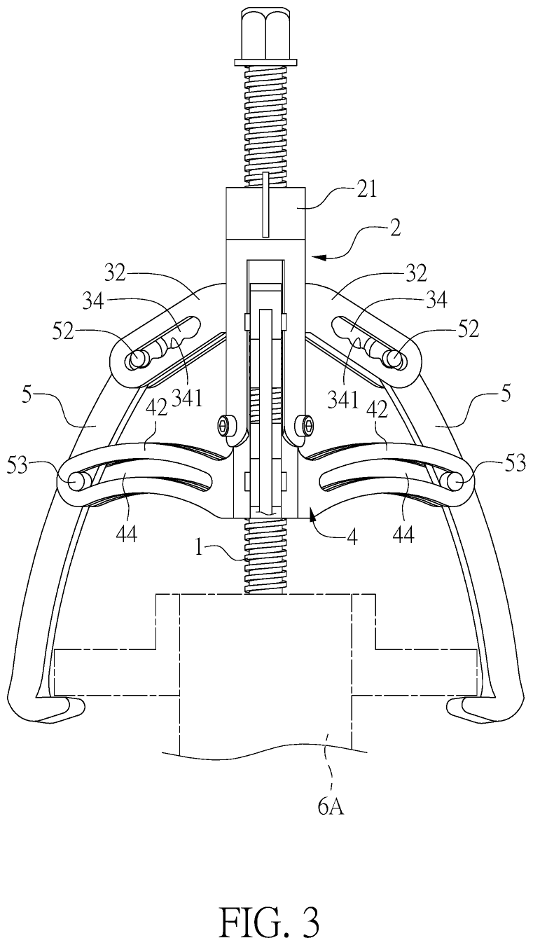

The puller structure described above is used in the following manner. To begin with, referring to FIG. 3, the wing nut 21 is operated to adapt the puller structure to the size of the workpiece 6A to be worked on. More specifically, the wing nut 21 is operated to move the connecting member 2, in order for the connecting member 2 to move the driven base 4 and thereby adjust the second fixing arms 42 to appropriate positions. Then, with the first protruding blocks 52 and the second protruding blocks 53 of each gripping arm 5 sliding freely in the corresponding first slide slots 34 and the corresponding second slide slots 44 respectively, the gripping arms 5 are opened as wide as the workpiece 6A and eventually fastened to the workpiece 6A so that the threaded rod 1 can be rotated to pull out the shaft in the workpiece 6A. While the shaft is being pulled, the gripping arms 5 will be securely positioned because the first protruding blocks 52 of each gripping arm 5 are respectively engaged in particular ones of the positioning recesses 341 of the corresponding first slide slots 34.

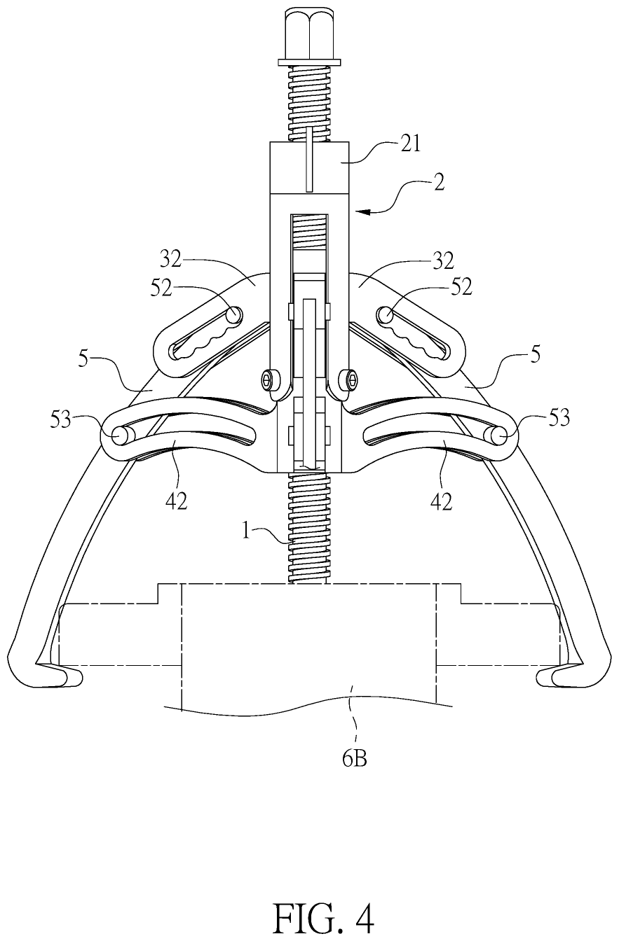

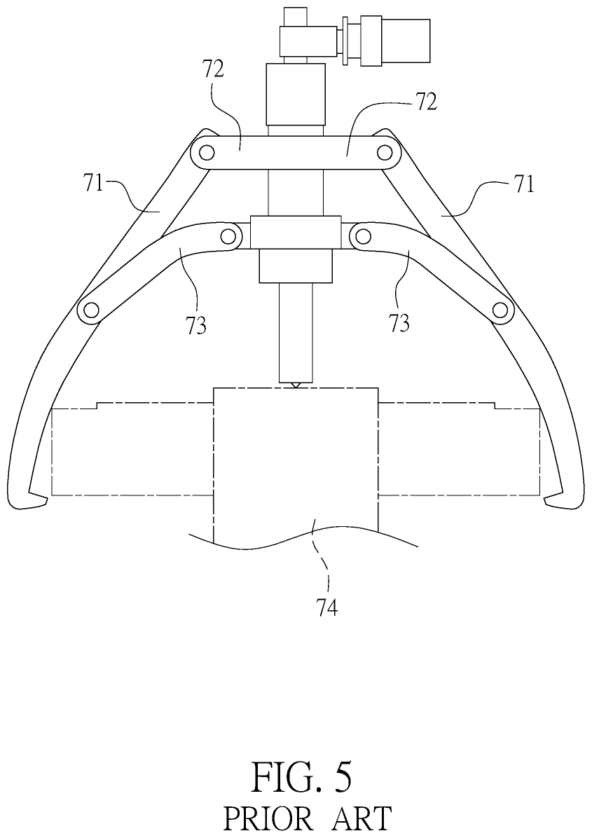

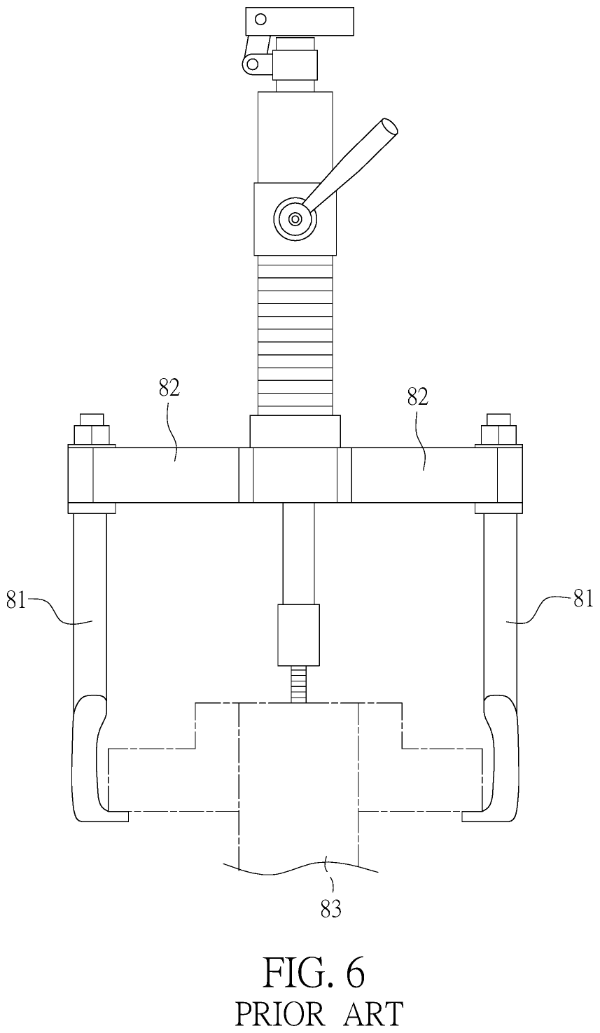

According to the above, the span of, and the gripping distance between, the gripping arms 5 can be adjusted by varying the positions at which each gripping arm 5 is connected respectively to the corresponding first fixing arm 32 and the corresponding second fixing arm 42, and this allows the puller structure to adapt to workpieces of different sizes. When the puller structure is used on a workpiece 6B (see FIG. 4) wider than the workpiece 6A in FIG. 3, the first protruding blocks 52 at the top end of each gripping arm 5 can be slid inward with respect to the corresponding first fixing arm 32 (i.e., the position at which each gripping arm 5 is connected to the corresponding first fixing arm 32 can be moved inward with respect to the corresponding first fixing arm 32), and the second protruding blocks 53 on the middle section of each gripping arm 5 can be slid outward with respect to the corresponding second fixing arm 42 (i.e., the position at which each gripping arm 5 is connected to the corresponding second fixing arm 42 can be moved outward with respect to the corresponding second fixing arm 42), in order to further increase the span of, and the gripping distance between, the gripping arms 5 and thereby adapt the puller structure to the workpiece 6B.

Another advantage of the present invention is that, while the disclosed puller structure is applicable to relatively large workpieces, the space occupied by the puller structure is smaller than its prior art counterparts because the first fixing arms 32 are shorter than the second fixing arms 42.

What is claimed is:

1. A puller structure, comprising a threaded rod, a connecting member, a fixing base, and a driven base, wherein the fixing base is provided with a threaded hole, the driven base is provided with a through hole, the connecting member has a top end provided with a wing nut, the threaded rod extends downward through and is threadedly connected with the wing nut and the threaded hole of the fixing base and then extends through the through hole of the driven base, the connecting member is downwardly extended with a plurality of extension arms that are arranged at intervals, the extension arms are fixedly connected to the driven base, the fixing base is provided with a plurality of first fixing arms that extend outward, the driven base is provided with a plurality of second fixing arms that extend outward, the first fixing arms extend through gaps between the extension arms respectively, the first fixing arms correspond in position to the second fixing arms vertically and respectively, and each said first fixing arm and a corresponding said second fixing arm are connected with a gripping arm, the puller structure being characterized in that:
the first fixing arms extend obliquely downward from the fixing base, the second fixing arms extend in a curved manner from the driven base, each said first fixing arm has a shorter length than the corresponding second fixing arm, each said first fixing arm is provided with a first groove that extends in a same direction as the each said first fixing arm, each said second fixing arm is provided with a second groove that extends in a same direction as the each said second fixing arm, and each said gripping arm is slidably provided in a corresponding said first groove and a corresponding said second groove via a first protruding block and a second protruding block respectively.

2. The puller structure of claim 1, wherein the first groove of each said first fixing arm is upwardly concavely provided in a bottom side of each said first fixing arm, each said first fixing arm has two lateral sides each formed with a first slide slot, each said first slide slot has a bottom edge provided with a plurality of positioning recesses that form a wavy shape, and two first protruding blocks are provided respectively on two lateral portions of each said gripping arm that face the first slide slots of a corresponding said first fixing arm and extend through the first slide slots of the corresponding first fixing arm.

3. The puller structure of claim 2, wherein the second groove of each said second fixing arm penetrates the each said second fixing arm vertically, each said second fixing arm has two lateral sides each formed with a second slide slot, and two second protruding blocks are provided respectively on two lateral portions of each said gripping arm that face the second slide slots of a corresponding said second fixing arm and extend through the second slide slots of the corresponding second fixing arm.
